(19) United States
(12) Patent Application Publication
(10) Pub. No.: US 2018/0165630 A1
(43) Pub. Date: Jun. 14, 2018

(54) APPARATUS AND METHOD OF IMPROVING TIME-SENSITIVE INVENTORY TRANSFERS WITHIN THE RETAIL AUTOMOBILE INDUSTRY

(71) Applicant: DINA A. GIFFORD, GRANITE BAY, CA (US)

(72) Inventor: DINA A. GIFFORD, GRANITE BAY, CA (US)

(21) Appl. No.: 15/378,193

(22) Filed: Dec. 14, 2016

(51) Int. Cl. G06Q 10/08; G01S 19/42; G01C 21/34; G06Q 10/06

(52) U.S. Cl. CPC G06Q 10/0832; G01S 19/42; G06Q 10/087; G06Q 10/063112; G06Q 10/063114; G01C 21/3438

(57) ABSTRACT

A apparatus and method of increasing the temporal and economic efficiency of vehicle inventory trades between automobile dealerships by communicating real-time demand for local, available qualified drivers to facilitate the transportation of such vehicles. Once a local, available, qualified driver is selected, he or she is instructed to travel to the location of the first traded vehicle, drive the first traded vehicle to the location second traded vehicle, and drive the second traded vehicle to the original location of the first traded vehicle to complete vehicle trade transaction. The driver's progress is communicated to both automobile dealership during the transportation.

### FIELD OF THE PRESENT DISCLOSURE

This disclosure relates generally to an apparatus and method of integrating marginal supply and marginal demand to realize greater economic and temporal efficiency, and more particularly to an apparatus and method of informing local, available, qualified drivers of real-time demand for drivers to assist with time-sensitive inventory transfers within the retail automobile industry.

### BACKGROUND OF THE RELATED ART

There are over 250 million personal passenger cars and trucks throughout the United States and, despite the availability of efficient public transportation options in many cities, the personal passenger car and/or truck is, by far, the primary mode of transportation for most people throughout the country. This preference is showing no sign of slowing as automobile manufacturers reported record sales exceeding 17.3 million new cars and lightweight trucks in the year 2015.

The vast majority of this impressive number of new vehicles are not sold directly to the end users by the automobile manufacturers, but instead are sold through a vast network of retail automobile dealerships located throughout the country, with one in virtually every city of any size and with dozens located in larger cities, so that any potential customer, regardless of where he or she lives, is likely to be located only a few short miles from a retail automobile dealership and can conveniently stop by to ask questions to a salesman or look at, touch, and/or test drive any desired make or model vehicle.

In the past, such retail dealership locations were a necessity to simply inform the consumers throughout the country of the various makes and models that existed and were available for sale and the salesman served as a significant source of product information. Today, in the age of information, the Internet serves as the primary source of information for most consumers as almost any detail about any particular make or model is easily obtainable on-line with a little research.

The vast network of retail dealerships are still as necessary as they have ever been though because while the average consumer arrives at a dealership much more well informed than in years past, they still often want to physically look at, touch, and/or test drive a vehicle before they make a purchase, and while the average modern customer relies much less upon the salesman for technical information, the salesman still plays a very important role in guiding a consumer through the emotional process of making the ultimate decision to buy and ensuring that the purchasing experience is enjoyable.

Part of ensuring that the purchasing experience is enjoyable includes attempting to make the process proceed quickly and efficiently once the consumer has made the ultimate decision to buy. This effort serves both a customer service concern, to give the consumer the most pleasant buying experience possible, and a practical concern, because, as experienced vehicle sales professionals know well, the emotional component of a consumer's decision to buy can easily change if the consumer experiences inconvenient complications or delays before the purchase is finalized.

Providing a pleasant and efficient buying experience is not usually a difficult task if a consumer chooses to purchase a vehicle that is physically located at the dealership; however, perhaps as a consequence to the Internet age, consumers are usually very well aware of the various options and features that are available for any particular make and model and often times express a desire to purchase a vehicle configured with a set of options and features that is not presently available within the dealership's current inventory.

When such contingencies arise, the salesman will attempt to find a vehicle configured as the consumer desires in the inventory of other dealerships, both to accommodate the consumer's desires and to save the potential sale. This is often done through a computer database but may involve making telephone calls to other dealerships as well. If the salesman finds the ideally configured vehicle in the inventory of another dealership a trade or swap will be proposed for an equally valued inventory vehicle and the salesman will then attempt to arrange for transportation of both vehicles.

Arranging for a quick and efficient transportation for both vehicles can be difficult if not impossible. Most trucking companies have fully booked schedules for at least the present week, so trucking companies typically request at least a one week lead time to perform any new jobs. This may be true even when the dealerships are only a few miles apart. Trucking companies are also typically quite expensive due, in part, to the increasing highway tax, insurance, and regulatory requirements for a commercial trucking companies. Also, while dealerships routinely trade inventory, their shipping volumes are typically not high enough to negotiate favorable pricing based on the economy of scale. There exists a need for an economical delivery system for vehicles traded between automotive dealerships, especially automobile dealerships that are located in relative close proximity.

Whatsmore, in many cases, a week delay is not only inconvenient, its unacceptable. In some such cases the consumer may be in the market for a new vehicle because their former vehicle is not operational and they have an immediate, hard obligation that requires an operational personal vehicle, like commuting to and from their job or performing work with their own vehicle. In other cases, the consumer might merely be impatient and not want to wait a week to take delivery of their new vehicle.

In such situations, a salesman must arrange for expedited delivery or risk losing the sale, or at very least, losing their customer's satisfaction. As with any other industry, expedited service is even more pricey and many times even expedited service may still not provide same-day or next-day services. There exists a need for same-day or next-day expedited services for accommodating the delivery of vehicles trades between automotive dealerships.

Some salesmen will attempt to solve this problem by driving the traded cars themselves or having dealership staff drive the cars. While this solution may save the immediate sale, it is not an efficient use of resources because both the salesman or the dealership staff typically have other more important duties that will necessarily be neglected if they choose to expend their time driving the traded vehicles.

Still other dealerships have considered procuring full time drivers and/or delivery trucks to handle vehicle trades; however, while industry wide vehicle trades happen continuously (by one account approximately 3,500 trades occurred between approximately 75 dealerships in one city during the course of one month), typically a single dealership does not have full time need for a driver and/or a delivery truck; therefore the total cost of full time driver employment and/or ownership of a delivery truck would likely prove to be prohibitably high.

Further, if a dealership is so large that it could utilize a fill time driver and/or delivery truck it would likely have a need for more than one driver and/or delivery truck at peek sales times; therefore, this option may prove limited as well because of the difficulty of expanding and contracting resources when necessary. There exists need for a system that provides automobile dealerships with the ability to rapidly expand and contract available delivery resources to accommodate fluctuating need in order to service such fluctuating need without excessive overhead.

The present disclosure distinguishes over the related art providing heretofore unknown advantages as described in the following summary.

### BRIEF SUMMARY OF THE INVENTION

The present disclosure describes an apparatus and method of notifying local, qualified, available drivers of time-sensitive demands for drivers to facilitate vehicle transportations needs of automobile dealerships.

The most effective method of reducing the cost of servicing any demand is to increase supply by assembling and organizing an existing fractured, disorganized, or to otherwise unutilized supply. In regards to the problem of transporting vehicles traded by automobile dealerships, the demand is for a driver to be present and available at the location of a recently traded vehicle to facilitate the transportation of such vehicle, and the supply is the thousands of likely available, qualified drivers in the surrounding local communities of the automobile dealerships that are ready and willing to provide assistance if they were notified of the real-time need for their services.

Currently, this supply of local, available, qualified drivers remains fractured, disorganized and/or unutilized because there exists no convenient and efficient system and method of informing these local, available, qualified drivers in real real-time of when and where an automobile dealership or other party would like to contract with a driver to utilize their driving services. The presently disclosed apparatus and method aims to change this current situation.

The present disclosure describes an apparatus and method of organizing the supply of local, available, qualified drivers so that when an automobile dealership makes vehicle inventory trade with another automobile dealership, all participating qualified drivers in the local area may be quickly and efficiently notified of the real-time demand for their driving skills and those notified drivers that are immediately available and willing fulfill the real-time demand may respond by remotely communicating their availability. By connecting demand with local otherwise unutilized supply, the apparatus and methods provides a rapid and cost effective solution for automobile dealerships in need of transporting vehicle inventory trades that is scalable to meet demand a dealership experiences even if such demand fluctuates.

An exemplary embodiment of the apparatus and method the following basic steps: 1) initiating a request for a local, qualified, available driver through electronic communication located within a specific geographic zone; 2) selecting a driver among local, available, qualified drivers located within the specific geographic zone that initiate confirmatory responsive electronic communication; 4) providing the driver with custody of the a first traded vehicle upon driver's arrival at the location of the first traded vehicle; 5) taking custody of first traded vehicle and proving driver with custody of second traded vehicle upon driver's arrival at the location of second traded vehicle with first traded vehicle; and 6) taking custody of the second traded vehicle and ending the transaction upon arrival at the original location of the first traded vehicle with the second traded vehicle.

The presently disclosed apparatus and method may utilize standard programmable computers programmed with and executing software to facilitate electromagnetic communication through the Internet protocol and/or telephonic protocol, mobile or otherwise, to facilitate electromagnetic communication. In preferred embodiments, the drivers would receive and transmit electromagnetic communication through mobile telephonic electronic devices with GPS capabilities so that the drivers can remain in electromagnetic communication with the automobile dealerships during the entire transportation process and transmit real-time location progress updates. Other embodiments may simply provide periodic location updates or calculate progress estimations based on arrival and departure times and delivery distance.

With regard to selecting qualified drivers, a preferred embodiment would include some level of certification of a driver's driving skills and driving history upon applying for participation in the system. Some embodiments may include a relatively streamlined application process only confirming that the driver has a current driver's license and proper insurance, while other embodiments may require demonstration of a clean driving record and require proof additional financial responsibility or a surety bond.

It is contemplated that a portion of the cost savings of the presently disclosed apparatus and method is derived from the fact that commercial shipping and transportation regulations and fees would not apply as the drivers would be merely driving passenger cars and trucks; however, in some embodiments it may be preferred that the drivers transport the vehicles on trucks. In these embodiments, commercial licenses and compliance with commercial shipping regulation would also be confirmed before a potential driver could participate in the system.

The presently disclosed apparatus and method may select drivers in a variety of manners. A primary consideration should always be the physical distance that the driver is located from the location of the first traded vehicle at the time the request for a driver is communicated. Some embodiments may only send requests to drivers located within a specific geographic region or only to potential drivers located within a predetermined radius around the location of the first traded vehicle. Other embodiments may send requests system wide and merely select the most preferable driver from among the responding drivers. Still other embodiments may weigh performance criteria as well as location when selecting a driver, such as the number a successfully completed jobs in the past, the rating given to the driver by the automobile dealership personnel, and/or the driver's past record of timeliness. Regardless of the manner in which the embodiment selects a driver among the responding drivers, a confirmatory message should be sent to the selected driver notifying him or her of the location of the first traded vehicles and the performance expectations.

Upon the arrival of the selected driver at the location of the first traded vehicle the driver is given custody of the first traded vehicle and instructed to proceed to drive the vehicle to the location of the second traded vehicle. In preferred embodiments, both automobile dealership can track the drivers progress in real-time because the driver's GPS enabled mobile device is transmitting its current location continuously or at intervals throughout the route. This feature also gives the both automobile dealerships the ability to better anticipate and prepare for the driver's arrival.

Upon arriving at the location of the second dealership, the substantially similar in size to the sides of the industry standard

This disclosure teaches certain benefits in construction and use which give rise to the objectives described below.

A primary objective to provide a more temporally efficient apparatus and method of facilitating inventory transfers within the retail automobile industry.

Another objective is to provide a more economically efficient apparatus and method of facilitating inventory transfers within the retail automobile industry.

A further objective is to provide a rapidly scalable apparatus and method of facilitating inventory transfers within the retail automobile industry to meet fluctuating demand.

A still further objective is to provide apparatus and method that can assist retail purveyors of automobiles increase sales by removing consumer objections related to a lack of vehicular selection or vehicle inventory.

A yet still further objective is to increase customer service in the retail automobile industry by providing purveyors more real-time or near real-time information regarding inventory transfers.

Other features and advantages of the present invention will become apparent from the following more detailed description, taken in conjunction with the accompanying drawings, which illustrate, by way of example, the principles and features of the presently described apparatus.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is a representative diagram of an exemplary embodiment of the presently disclosed apparatus and method illustrating the electromagnetic communication between a dealership and local, available, qualified drivers in contemplation of contracting to facilitate inventory swap.

FIG. 2 is representative diagram of an exemplary embodiment of the presently disclosed apparatus and method illustrating a salesman at a dealership initiating an electronic communication to local, available, qualified drivers in contemplation of contracting to facilitate an inventory swap.

FIG. 3 is representative illustration of a local, available, qualified driver receiving an electromagnetic communication from a dealership in contemplation of contracting to facilitate an inventory swap and an exemplary representation of the information that may be included in such electromagnetic communication displayed on a mobile device.

FIG. 4 is representative illustration of a salesman at an automobile dealership receiving responsive electromagnetic communication from a local, available, qualified drivers and an exemplary representation of the information that may be included in such responsive electromagnetic communication displayed on a on a mobile device.

FIG. 5 is representative illustration of a salesman at an automobile dealership receiving electronic communication concerning the progress of an inventory swap and an exemplary representation of the information that may be included in such electromagnetic communication of the transit progress displayed on a mobile device.

FIG. 6 is a flow chart setting forth the basic steps of a simple exemplary embodiment of the presently disclosed apparatus and method.

### DETAILED DESCRIPTION OF THE EXEMPLARY EMBODIMENT

The above described drawing figures illustrate an exemplary embodiment of presently disclosed apparatus and its many features in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus or its many features.

Described now in detail is an apparatus and method of improving time-sensitive inventory transfers within the retail automotive industry.

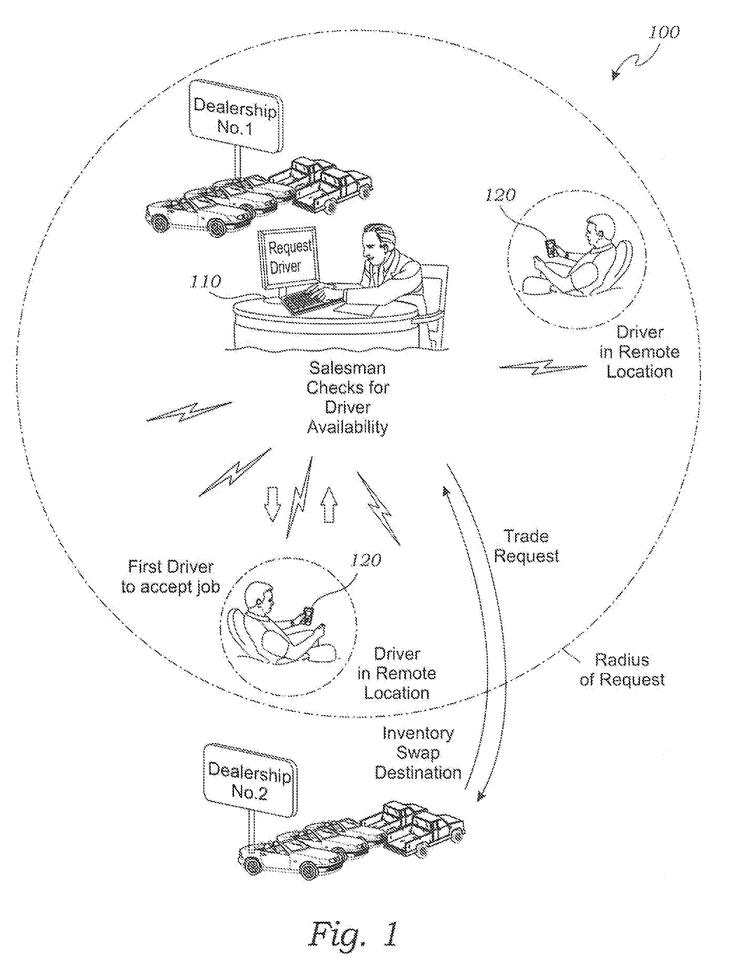

FIG. 1 illustrates an exemplary representation of an automobile dealership that has reached an agreement to trade an inventory vehicle with a second dealership to facilitate a sale and is in need of a method of quickly and inexpensively transporting both recently the traded vehicles. A salesman is shown entering a request for local, available, qualified driver into a master transceiver device 110 which is a general purpose programmable computer, programmed with and executing software and/or firmware that instructs and performs the presently disclosed method. The master transceiver device 110 and is capable of transceiving electromagnetic communication through Internet, telephone, and/or wireless telephone protocols. In FIG. 1 the master transceiver device 110 is illustrated as a desktop computer, however, in other embodiments such master transceiver may be a mobile device such as a smart phone.

Local, available, qualified drivers within the geographic region may receive the communication through mobile transceiver devices 120 which are ground positioning system enabled programmable computers that are programmed with and executing software that instructs the presently disclosed method, and/or firmware that instruct the presently disclosed method, and/or some combination thereof.

In some embodiments, the request is communicated in only specific geographical regions. In FIG. 1, the specific geographic region is represented by the dashed circle. In other embodiments the specific geographic region is defined by a particular metropolitan area or the estimated time required to arrive at a particular location given the local road and traffic conditions. Still other embodiments may not restrict the request communication to any particular region, instead relying of the system to choose an appropriately located available, qualified driver.

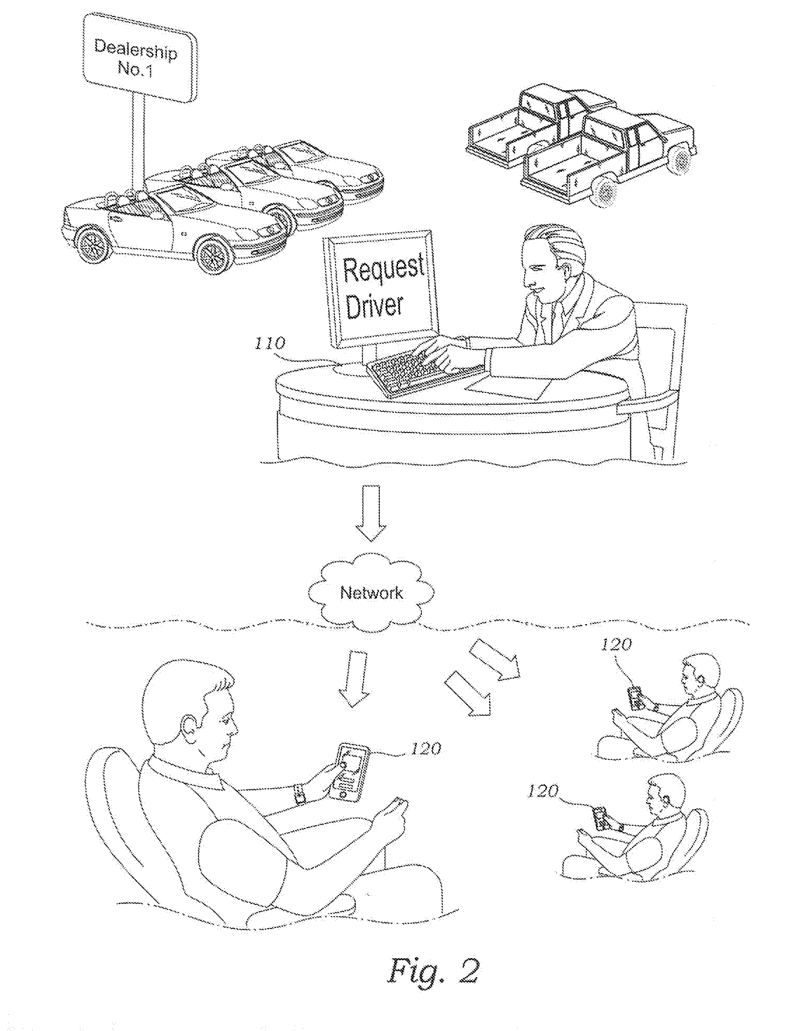

FIG. 2 illustrates several local available qualified drivers receiving the transfer opportunity request communication on their model transceiver devices 120. When there is more than one driver to choose from the system must utilize a predetermined selection criteria to select which driver is awarded the inventory transfer opportunity. In some embodiments, the system may select the driver located geographically or temporally closest to the location of the first traded vehicle. In other embodiments, the system may consider the number of previously successfully completed inventory transfer opportunities or the performance rating assigned based on previous performance metrics such as timeliness, safety record and/or dealership satisfaction.

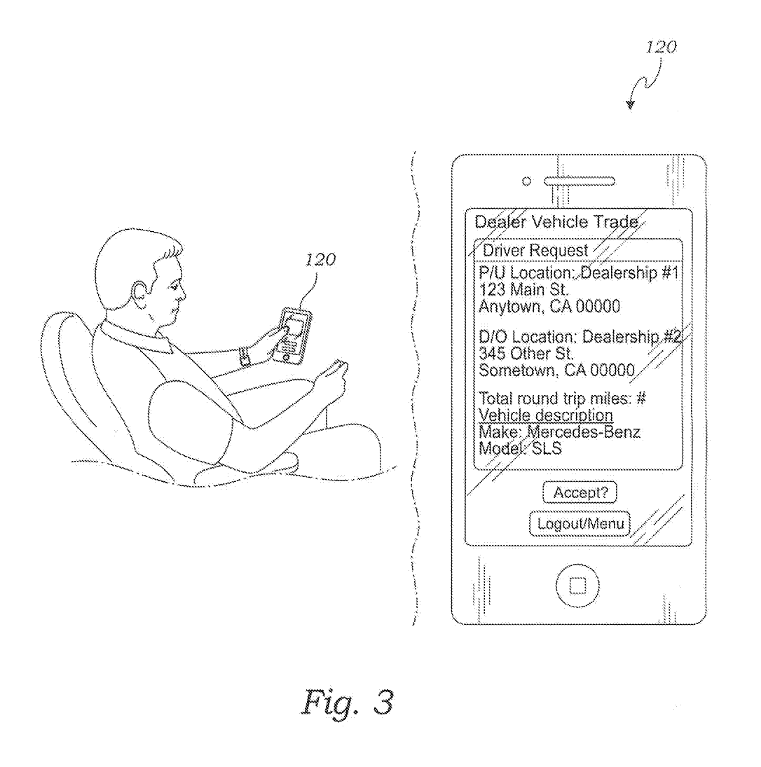

FIG. 3 illustrates a representation of a local, available, qualified driver that has been awarded an inventory transfer opportunity and an exemplary representation of the information that may be communicated to the mobile transceiver device 120 when and inventory transfer opportunity is awarded. In the embodiment the driver receives the pick-up location of the first traded vehicle, the drop-off location of the first traded vehicle where the driver will pick-up the second traded vehicle, the estimated round trip mileage, and the make and the model of the vehicle that the driver will be transporting.

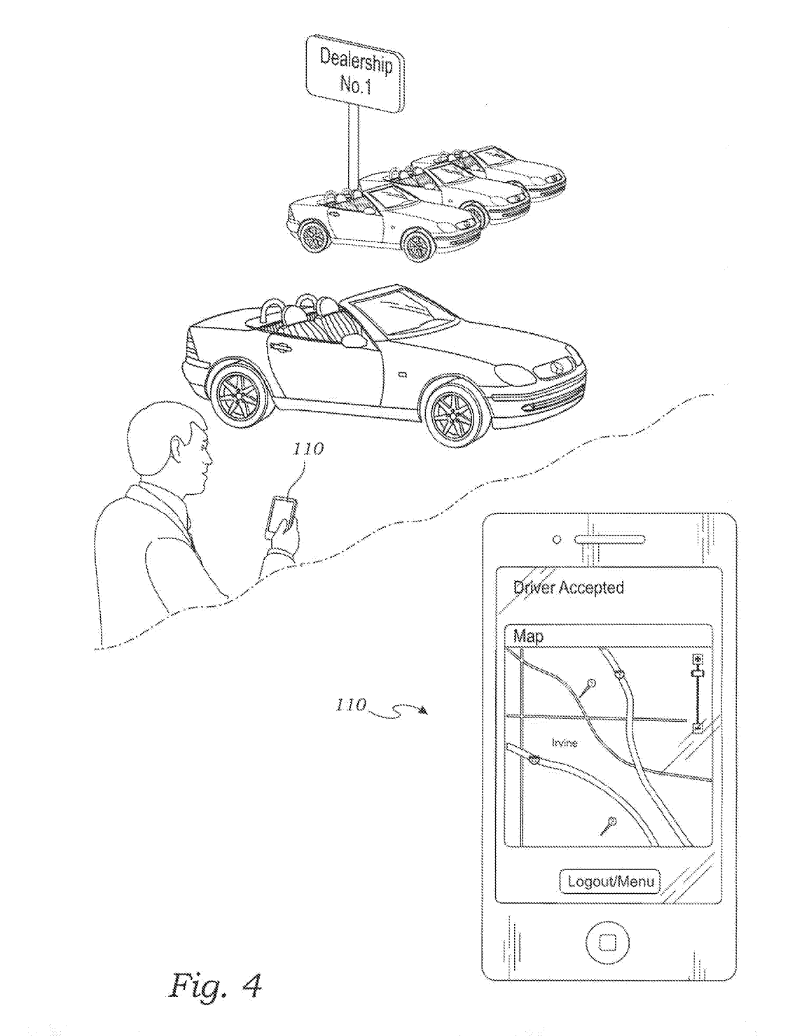

FIG. 4 illustrates a representation of a salesman tracking the progress of a driver that is in the process of transporting a traded vehicle on a master transceiver device 110 and an exemplary representation of how the location update interface may appear. In this particular embodiment, the salesman can view a representation of the traded vehicle moving along a graphical representation of a local map and therefore have real-time understanding of the vehicles current location. Other embodiments may be more elaborate providing such data as estimated time of arrival and current speed, while other embodiments may merely provide periodic location update. A master transceiver device 110 may take the form of a desktop computer as illustrated in FIG. 1 or a mobile device as illustrated in FIG. 4.

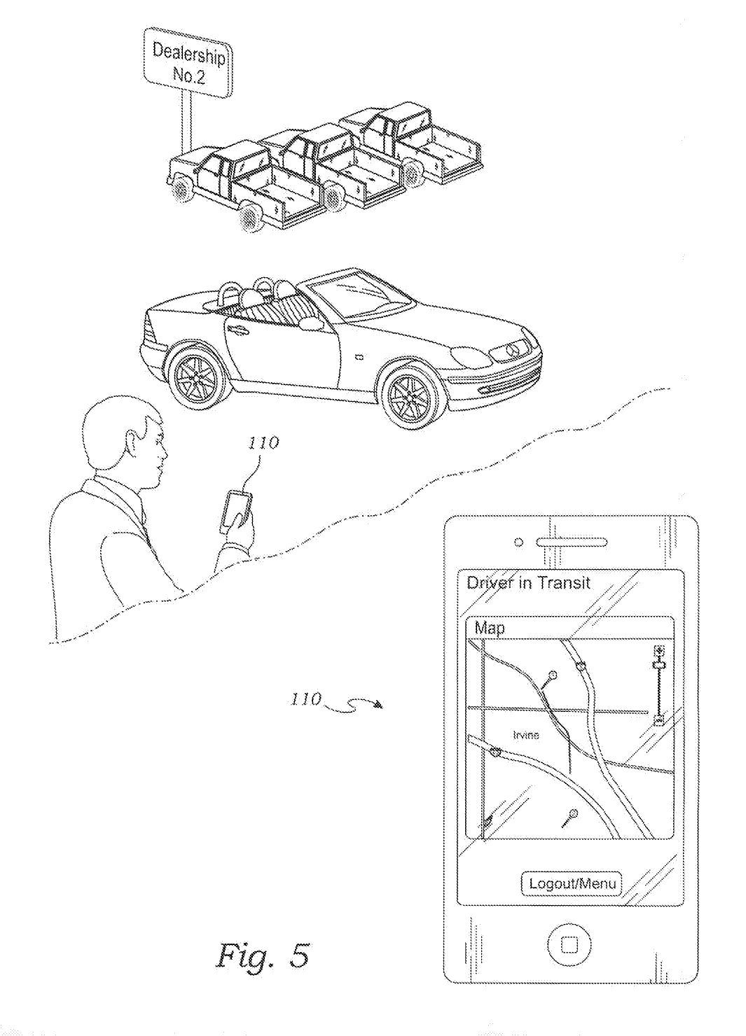

FIG. 5 illustrates that the salesman or dealership staff at the location of the second traded vehicle may receive progress data as well on a master transceiver device 110. Such information allows salesmen and dealership staff to better schedule their obligations and utilize their time more efficiently and productively.

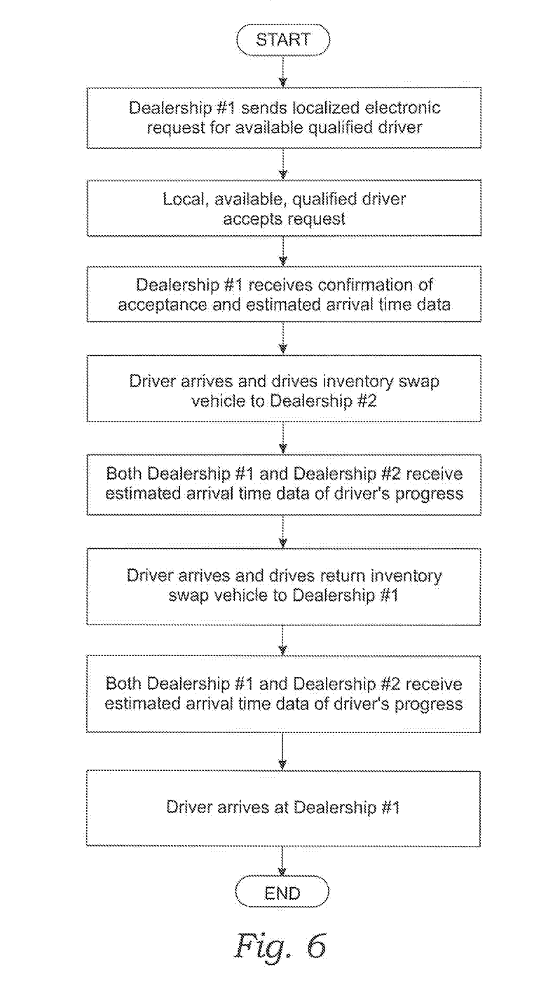

FIG. 6 illustrates a flow chart of the basic steps of the method of the presently disclosure. In its most basic form the method involves the steps of: 1) communicating an inventory transfer opportunity; 2) selecting a driver among local, available, qualified drivers; 3) communicating the selection to the selected local, available, qualified driver; 4) providing the driver with custody of the a first traded vehicle upon driver's arrival at the location of the first traded vehicle; 5) allowing driver to transfer first traded vehicle to location of second traded vehicle; 6) taking custody of first traded vehicle and providing driver with custody of second traded vehicle upon driver's arrival at the location of the second traded vehicle; 7) allowing driver to transfer second traded vehicle to original location of the first traded vehicle; and 8) taking custody of the second traded vehicle and ending the transaction upon driver's arrival at the original location of the first traded vehicle.

It is contemplated that the inventory vehicle trade could also occur in reverse where the local, available, qualified driver arrives at the automobile dealership that did not initiate the trade request first because of his or her original location or some other factor of convenience. In such case the description of first traded vehicle and second traded vehicle should be defined as the first vehicle the driver arrives at and the second vehicle the driver arrives at, respectively.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus for improving the efficiency of time-sensitive inventory transfers in the automotive industry by utilizing local, available, qualified drivers, the apparatus comprising:
at least one master transceiver device for electromagnetically communicating inventory transfer opportunity data to local, available, qualified drivers;
at least one GPS enabled mobile transceiver device associated with an available qualified driver for electromagnetically communicating driver availability data and driver location data;
wherein said at least one said master transceiver device is configured to electromagnetically communicate inventory transfer opportunity data to all said GPS enabled mobile transceiver devices within a predetermined geographic area which are configured to electromagnetically communicate the driver availability data and driver location data of the associated qualified driver such that said at least one master transceiver device may determine the availability and location of all qualified drivers within the predetermined geographic area and select one qualified driver based on predetermined selection criteria and electromagnetically communicate a selection notification to said GPS enabled mobile transceiver device associated with the selected qualified driver such the selected available driver may execute the inventory transfer according to the inventory transfer data.

2. An apparatus as described in claim 1 wherein said inventory transfer opportunity data comprises the address of the location of a first traded vehicle, the address location of the second traded vehicle, and the estimated total mileage of the inventory transfer opportunity.

3. An apparatus as described in claim 2 wherein said predetermined geographic area is defined by radial distance from the address of the location of the first traded vehicle.

4. An apparatus as described in claim 2 wherein predetermined geographic area is defined by the estimated time of arrival of a qualified driver to location of the first traded vehicle given road and traffic conditions.

5. An apparatus as described in claim 2 wherein predetermined geographic area is defined by the geographic limits of the particular metropolitan area encompassing the address of the location of the first traded vehicle.

6. An apparatus as described in claim 2 wherein predetermined geographic area is defined as system wide without geographic limits.

7. An apparatus as in claim 2 wherein said predetermined selection criteria comprises current driver location and estimated travel time from the driver's current location to the location of first traded vehicle given current road and traffic conditions.

8. An apparatus as in claim 2 wherein said predetermined selection criteria additionally comprises driver performance ratings from past completed inventory transfer opportunities.

9. An apparatus as described in claim 2 wherein said predetermined selection criteria comprises favoring the temporal order in which the qualified drivers respond to the inventory transfer opportunity data communication.

10. An apparatus as in claim 8 wherein upon receiving selection notification said GPS enabled mobile transceiver device associated with selected qualified driver begins electromagnetically communicating location data at regular intervals until inventory transfer opportunity is completed.

11. A method for improving the efficiency of time-sensitive inventory transfers in the automotive industry by utilizing local, available, qualified drivers to facilitate such transfers, the method comprising the steps of:
1) electromagnetically communicating an inventory transfer opportunity data to available, qualified drivers located within a predetermined geographic area;
2) selecting a driver among available, qualified drivers located within a predetermined to geographic area based on predetermined selection criteria;
3) communicating selection notification to selected available, qualified driver;
4) providing the selected driver with custody of the a first traded vehicle upon driver's arrival at the location of the first traded vehicle;
5) allowing driver to transfer first traded vehicle to location of second traded vehicle;
6) taking custody of first traded vehicle and providing driver with custody of second traded vehicle upon driver's arrival at the location of the second traded vehicle;
7) allowing driver to transfer second traded vehicle to original location of first traded vehicle;
8) taking custody of the second traded vehicle and ending the transaction upon driver's arrival at the original location of the first traded vehicle.

12. A method as in claim 11 wherein said inventory transfer opportunity data comprises the address of the location of a first traded vehicle, the address location of the second traded vehicle, and the estimated total mileage of the inventory transfer opportunity.

13. A method as in claim 12 wherein said predetermined geographic area is defined by radial distance from the address of the location of the first traded vehicle.

14. A method as in claim 12 wherein said predetermined geographic area is defined by the estimated time of arrival of a qualified driver to location of the first traded vehicle given road and traffic conditions.

15. A method as in claim 12 wherein said predetermined geographic area is defined by the geographic limits of the particular metropolitan area encompassing the address of the location of the first traded vehicle.

16. A method as in claim 12 wherein said predetermined selection criteria comprises current driver location and estimated travel time from the driver's current location to location of first traded vehicle.

17. A method as in claim 12 wherein said predetermined selection criteria comprises current driver location and estimated travel time from the driver's current location to location of first traded vehicle.

18. A method as in claim 12 wherein said predetermined selection criteria current additionally comprises driver performance ratings from past completed inventory transfer opportunities.

19. A method as in claim 12 wherein said predetermined selection criteria current additionally comprises favoring the temporal order in which the qualified drivers respond to the inventory transfer opportunity data communication.

20. A method as in claim 11 further comprising the step of communicating available qualified driver's location continuously after available qualified driver is selected until inventory transfer opportunity is completed.
